(19) United States
(12) Patent Application Publication
(10) Pub. No.: US 2008/0320011 A1
(43) Pub. Date: Dec. 25, 2008

(54) INCREASING FILE STORAGE SCALE USING FEDERATED REPOSITORIES

(75) Inventors: Sterling J. Crockett, Bothell, WA (US); John D. Fan, Duval, WA (US); Dustin G. Friesenhahn, Seattle, WA (US); Adam D. Harmetz, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/765,747

(22) Filed: Jun. 20, 2007

(51) Int. Cl. G06F 17/30

(52) U.S. Cl. 707/100; 707/E17.044

(57) ABSTRACT

A storage management system using federated repositories directs content to child repositories in a hierarchical structure. A service for managing the storage maintains a list of active and historic repositories and routing of the content for storage is performed based on a file plan that includes the structure of the child repositories, policies for storage, and the like. Repositories reaching their capacity are retired to historic status, where they are available for search purposes, but not for further storage. File plan is updated as new repositories are added or old ones retired. File plan changes and other information such as content types, search terms, workflow, etc. is made available to child repositories when they query the service.

### BACKGROUND

Many corporations and organizations have large sets of electronic content with requirements to be stored and maintained for defined periods of time. As time passes, these sets of content tend to grow, and ultimately reach a size which is often too great for a single repository. Nonetheless, the organization needs to manage this content in a uniform way, even if the content itself is partitioned across several physical stores.

Managing such electronic content may present additional challenges since policies associated with the content may also need to be modified over time. For example, in its first year of business, a company may have 20 million files detailing research and trials, each of which may have to be retained for 11 years, and its repository may be limited to a total of 20 million files. Without being able to expand the physical size of that existing repository, and because their records must be retained for many years, the company may end up with several disjointed repositories that need to be managed separately. This increases the challenges on managing the company's records, particularly in cases where policies applicable to the content across repositories may have to be modified.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to content storage management using federated repositories. A storage management service may manage child repositories adding new ones or retiring those that reach their capacity, maintaining a file plan for routing content up-to-date with the available and historic child repository information.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a conceptual diagram illustrating management of content storage by a storage management service coordinating multiple child repositories;

FIG. 2 illustrates details of an example storage management service managing multiple storage repositories;

FIG. 3 is an example networked environment, where embodiments may be implemented;

FIG. 4 is a block diagram of an example computing operating environment, where embodiments may be implemented; and

FIG. 5 illustrates a logic flow diagram of an example content storage process according to embodiments.

### DETAILED DESCRIPTION

As briefly described above, file storage scale may be increased and optimized using federated repositories managed by a storage management service. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

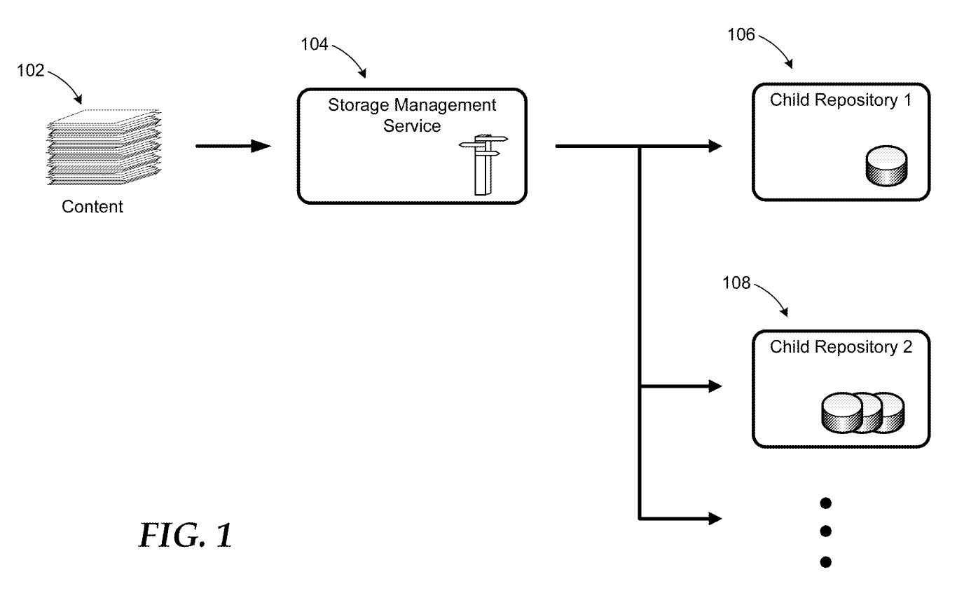

Referring to FIG. 1, a conceptual diagram illustrating management of content storage by a storage management service coordinating multiple child repositories is shown. Content that may be stored in a system according to embodiments may include data of any form such as textual data, files, video stream, audio stream, images, and the like. The content may also include a pointer to data that is stored in another system.

In a system according to embodiments, storage management service 104 may receive content 102 from a number of sources such as users, network nodes, input devices, and the like. Storage management service 104 maintains a hierarchical structure of child repositories (e.g. child repository 1, 2, etc.) ensures that information such as content types, field types, search terms, user roles, and so on are known system wide. Furthermore, storage management service 104 maintains a list of active (currently available to store content) and retired (no longer accepting content for storage, but available for other operations such as searches) child repositories and a file plan that is used to route received content to the applicable child repository for storage. Thus, storage management service 104 manages not only the stored content, but also properties of the storage repositories.

Policies, such as a retention policy, may be used in managing storage of content in the child repositories in conjunction with the file plan, where affected child repositories may be informed of the policy applicable to content stored in those.

Child repositories may include one or more virtual or physical data stores that may be managed by a server executing the storage management service 104 or by local servers, individually or in groups. For example, child repository 1 (106) may be a single data store managed by the hub server that also executed the storage management service 104. On the other hand, child repository 2 (108) may include a group of data stores managed by a separate database server. Any communication intended for the stores of child repository 2 may be directed to their database server.

An example scenario, according to one embodiment, may be as follows: a company has five active projects, and begins by creating a distributed enterprise repository with five “federated” repositories, each of which can hold 20 million records. Each project may be assigned to a separate repository. When a sixth project begins, a sixth repository may be added to the file plan through the central administration tool, and files for that project may be stored in the new repository. Unexpectedly, a new project may require ten times as much content as anticipated, and after only a brief period its assigned repository may be nearly full. In this case, a new repository may be added to the system, and new incoming content pertaining to the new project may be routed to the new repository. The original repository for the new project may be “retired” (i.e. new content is no longer placed there). Content may continue to be stored across the organization without a hindrance.

Modification of content storage systems according to embodiments is not limited to storage needs based on content size. Other reasons for adding new partition(s) to the system may include organizational and management based partitioning needs. For example, a project may be associated with highly sensitive content, that may be stored in a different (with appropriate attributes) repository.

Components of a storage management system using federated repositories may be executed over a distributed network, in individual servers, in a client device, and the like. Furthermore, the components described herein are for illustration purposes only, and do not constitute a limitation on the embodiments. A storage management system using federated repositories may be implemented using fewer or additional components in various orders. Individual components may be separate applications, or part of a single application. Moreover, the system or its components may include individually or collectively a user interface such as a web service, a Graphical User Interface (GUI), and the like.

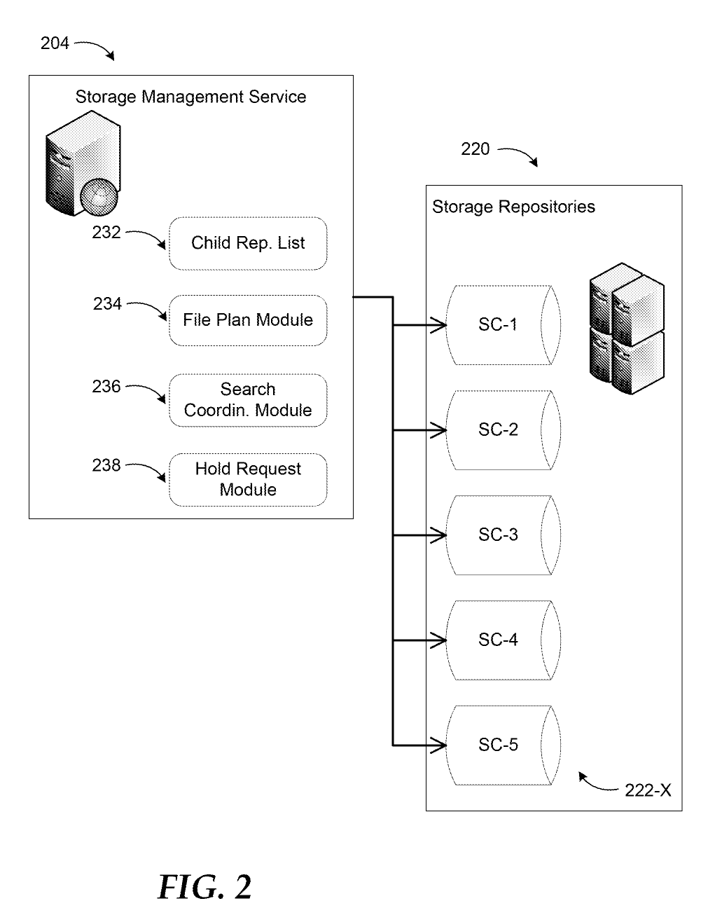

FIG. 2 illustrates details of an example storage management service managing multiple storage repositories. For child repositories to be correctly configured, and reflect the hierarchies, policies, and information such as content types, field types, search terms, user roles, specified at a hub of the storage management service 204, a channel of communication may be established between each child and the hub. The communication channel may be automatically configured according to some embodiments.

Storage management service 204 may be an application or a managed service executed on one or more servers. According to one embodiment, storage management service 204 may include a child repositories list 232 that includes a listing and hierarchy information of active and archive child repositories, a file plan module for routing received content to appropriate child repositories according to a file plan that may be based on policies, hierarchy structure, content type(s), related content, and so on. Storage management service 204 may further include a search coordination module 236 for coordinating searches and results for content stored in the child repositories and a hold request module 238 for issuing hold requests for specific content to child repositories changing a retention policy of the affected content.

Storage repositories 220 may include multiple site collections (SCs) managed individually or in groups by data store servers. SCs 222-X may include one or more physical and/or virtual data stores for storing content. Examples of items which may be communicated from the hub to its children include, but are not limited to, the following:
Content Types—When a new type of content is created at the global level, it may be desirable for all children of the hub to recognize it. Content type may also include metadata schema.
Policy—The organization may require, for example, that all content pertaining to a specific project is destroyed after a preset time period. The hub may instruct all affected children about this global policy.
File Plan—When the hierarchical structure of the overall file plan is modified, the affected children may also update their folder structure.
Other—In general, any item that may be defined at a global level and pertain to the repositories where content is stored. Examples of other items include field types, workflow, user roles, term sets, content re-use templates, etc.

Instead of being limited to locations in the local repository, the file plan may specify a location on a separate repository where particular content should be stored. When content is submitted to the record center, it can then be routed either locally or to a separate repository. The overall hierarchy for the file plan may be specified at the hub. When folder structure is specified in the file plan that needs to exist within a child repository, this structure may be created at the child repository automatically. To add more capacity at a given time to the overall records center, a new repository may be created and federated to the records center. Then the file plan may be modified to route content to the new repository. When a federated repository reaches its capacity, a new repository may be added and the routing of part of the file plan changed to point to the new repository as mentioned. The repository to which the file plan previously pointed may be managed as historical or archive storage of peer content.

A “hold” is when a set of records must be retained for an indeterminate amount of time (e.g. for legal purposes). When the need to hold all documents related to a specific topic or entity arises, a common command may be issued to all federated repositories to hold the appropriate content.

In an example operation, multiple repositories (“Children”) are created with a hierarchical structure. Such a repository may be a site object. A records center is created for management of all content. The records center includes a “Hub” associated with the storage management service (“Service”), but it also includes the Children. When changes (e.g. policy, folder hierarchy, content types, workflow, or field types) are made to the Hub, this is reported to the Service.

When queried, the Service may report what changes have occurred in the Hub since a given time, and provide any required updated objects. Each Child may be configured to query the Service on a periodic basis in order to receive the updates that specifically pertain to itself. It should be noted that a particular change, while pertaining to the given Child, may also pertain to the entire group of Children. In another embodiment, the Service may provide the changes to the affected children without being queried.

A file plan with hierarchical structure for routing files submitted to the records center may be created at the Hub. Certain nodes in the file plan may be designated as root nodes in the Children. Metadata in the node may indicate an identity of its associated Child. The identity and/or Uniform Resource Locator (URL) of the Child corresponding to each root node may be recorded in a non-decreasing list of all current or historical Children.

If the file plan is updated to contain folder hierarchy below a root node, this hierarchy and its associated root node may be reported to the Service. If a Child, when querying the Service, learns that the folder hierarchy below its root node has changed, the new hierarchy may be created or the existing one modified underneath the root node on the Child itself. When a document is submitted to the records center, and the file plan routes that document to a root node, the document may be stored at the root node in the associated Child. When a document is submitted to the records center, and the file plan routes that document to a folder underneath a root node, the document may be stored at a folder in the associated Child which corresponds to the specified folder in the file plan.

Once the Hub has been established, a Child may be created and configured to query the Service for updates. Also, a root node may be configured in the file plan to point to a Child which has not previously been used for storage. When a Child nears or reaches its storage capacity a new Child may be created and the file plan reconfigured so that the root node which directed new content to the old Child now directs them to the new Child. According to a further embodiment, a historical pointer to the old Child may be retained at the root node for reference purposes (but not for routing new content).

The old Child may be marked historical or archive so that no additional content is stored there, and it may continue to query the Service on a periodic basis. Moreover, the file plan may be updated at any time to change how content is routed, whether the content is routed to root nodes, or to folders underneath root nodes.

According to a yet other embodiment, an old Child may become active again if the archived content is deleted and the Child becomes available for storage again. In that case, the file plan may be updated to reflect the re-activation of the old Child.

A “Hold” occurs when a user indicates that all content relating to a specific topic or user is to be retained for an indeterminate amount of time. When this action is taken at the Hub, the Hub may issue a hold request to each Child in the Child List (or a sub group of Children). Each Child may perform a search over its local folder hierarchy, and mark content which match the search with a tag indicating they are associated with a hold. Then, each Child may create a list of all content associated with the hold and report this list back to the Hub. The Hub may collect the hold reports from each Child, and combine them into a single report for the issued hold request.

According to a yet other embodiment, the Hub may determine which root nodes in the file plan are affected by a change, when a content type is modified at the Hub or added to a node in the file plan. As part of its periodic queries to the Service, each Child may eventually ask if changes to the Hub have occurred. If the change to the content type affects a Child, it may download the new or updated content type, and apply it at the appropriate levels in its local folder hierarchy. The same process may be implemented for any change of the communicated items listed previously.

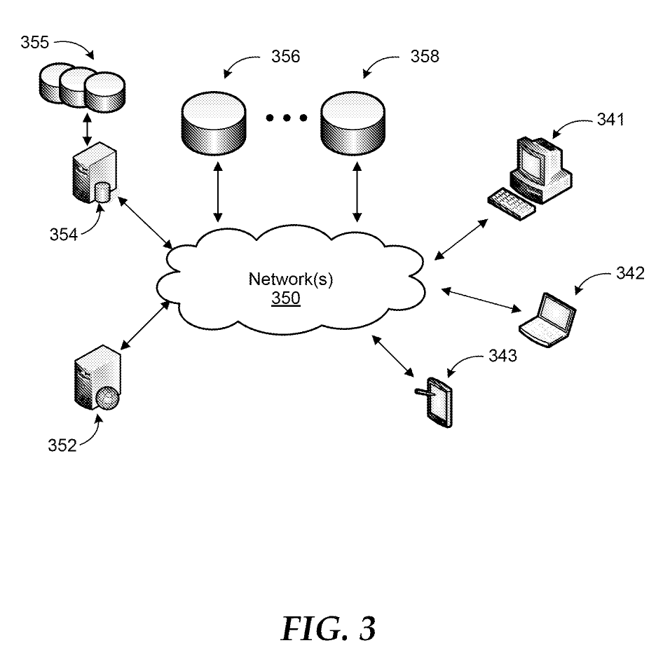

FIG. 3 is an example networked environment, where embodiments may be implemented. Storage management using federated repositories may be implemented locally on a single computing device or in one or more computing devices configured in a distributed manner over a number of physical and virtual clients and servers. It may also be implemented in un-clustered systems or clustered systems employing a number of nodes communicating over one or more networks (e.g. network(s) 350).

Such a system may comprise any topology of servers, clients, Internet service providers, and communication media. Also, the system may have a static or dynamic topology, where the roles of servers and clients within the system's hierarchy and their interrelations may be defined statically by an administrator or dynamically based on availability of devices, load balancing, and the like. The term “client” may refer to a client application or a client device. While a networked system implementing storage management using federated repositories may involve many more components, relevant ones are discussed in conjunction with this figure.

A content storage management system according to embodiments may receive content from a number of sources such as client devices 341-343. Parts or all of the storage management system may be implemented in server 452 and accessed from anyone of the client devices (or applications). Data stores associated with system (federated repositories) may include individual data stores (e.g. 356, 358) or a cluster of data stores (355) managed by a database server 354.

Network(s) 350 may include a secure network such as an enterprise network, an unsecure network such as a wireless open network, or the Internet. Network(s) 350 provide communication between the nodes described herein. By way of example, and not limitation, network(s) 350 may include wired media such as a wired network or direct-wired connection, and wireless media such as acoustic, RF, infrared and other wireless media.

Many other configurations of computing devices, applications, data sources, data distribution systems may be employed to implement content storage management using federated repositories. Furthermore, the networked environments discussed in FIG. 3 are for illustration purposes only. Embodiments are not limited to the example applications, modules, or processes.

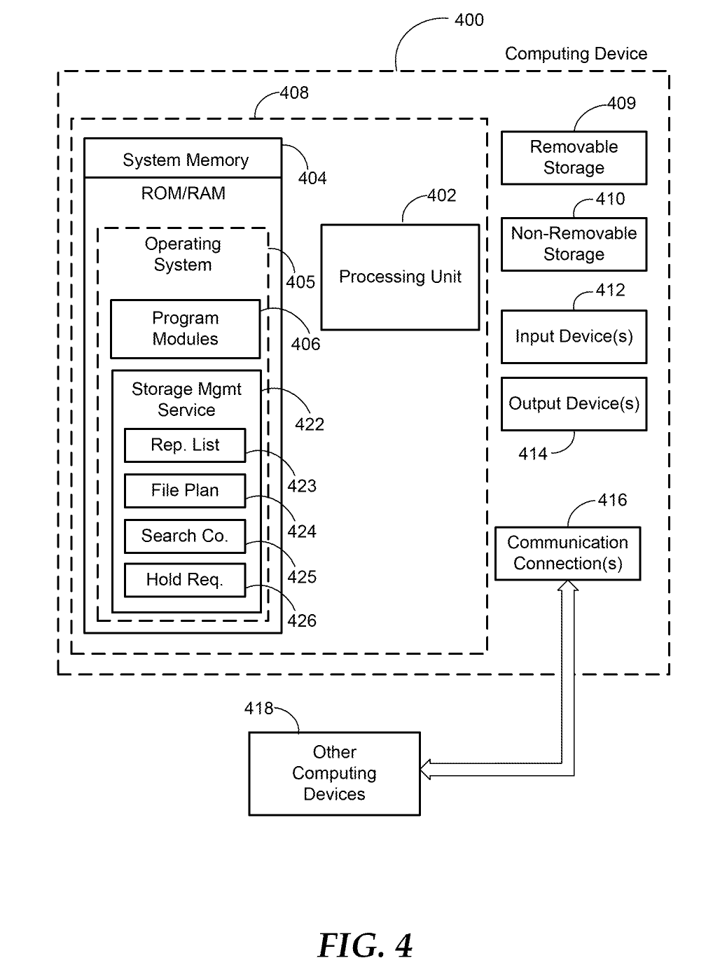

FIG. 4 and the associated discussion are intended to provide a brief, general description of a suitable computing environment in which embodiments may be implemented. With reference to FIG. 4, a block diagram of an example computing operating environment is illustrated, such as computing device 400. In a basic configuration, the computing device 400 may be a server or a client machine. Computing device 400 may typically include at least one processing unit 402 and system memory 404. Computing device 400 may also include a plurality of processing units that cooperate in executing programs. Depending on the exact configuration and type of computing device, the system memory 404 may be volatile (such as RAM), non-volatile (such as ROM, flash memory, etc.) or some combination of the two. System memory 404 typically includes an operating system 405 suitable for controlling the operation of a networked personal computer, such as the WINDOWS® operating systems from MICROSOFT CORPORATION of Redmond, Wash. The system memory 404 may also include one or more software applications such as program modules 406, storage management service 422, repository list 423, file plan module 424, search coordination module 425, and hold request module 426.

Storage management service 422 may be an application or a managed service providing content storage and search services to users. Storage management service 422 may be associated with additional modules than the ones illustrated for additional functionality associated with storing content in a federated repository system. Functionality and operations of repository list 423, file plan module 424, search coordination module 425, and hold request module 426 have been described previously. This basic configuration is illustrated in FIG. 4 by those components within dashed line 408.

The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by removable storage 409 and non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of device 400. Computing device 400 may also have input device(s) 412 such as keyboard, mouse, pen, voice input device, touch input device, etc. Output device(s) 414 such as a display, speakers, printer, etc. may also be included. These devices are well known in the art and need not be discussed at length here.

The computing device 400 may also contain communication connections 416 that allow the device to communicate with other computing devices 418, such as over a wireless network in a distributed computing environment, for example, an intranet or the Internet. Other computing devices 418 may include server(s). Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods of operation. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

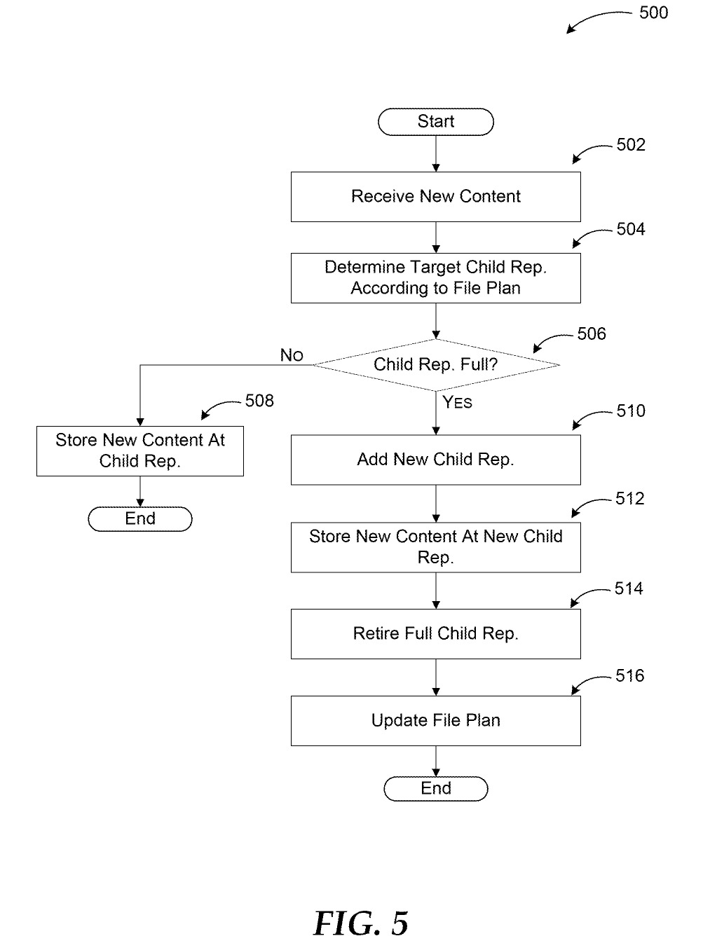

FIG. 5 illustrates a logic flow diagram of an example content storage process according to embodiments. Process 500 may be implemented as part of a storage management system.

Process 500 begins with operation 502, where new content is received for storage by the service. Processing advances from operation 502 to operation 504. At operation 504, a target child repository is determined based on the file plan as discussed previously. Processing continues to decision operation 506 from operation 504.

At decision operation 506, a determination is made whether the target child repository has reached its storage capacity (or a predefined limit). If the child repository has not reached its capacity, the new content is stored at the child repository in subsequent operation 508. If the child repository has reached its capacity, processing continues to operation 510.

At operation 510, a new child repository is added to the hierarchical system of federated repositories. A folder structure of the new child repository may be created or modified to match that prescribed by the file plan and the child repository provided information such as content types, and so on. Processing continues to operation 512 from operation 510.

At operation 512, the new content is stored at the newly added child repository. Processing continues to operation 514 from operation 512, where the child repository at full capacity is retired (i.e. designated as archive or history, and no longer eligible for storing additional content). Processing continues to operation 516 from operation 514.

At operation 516, the file plan is updated with the new child repository structure along with the child repository list maintained by the service. Other child repositories may be subsequently updated with the new information for navigation across child repositories. After operation 516, processing moves to a calling process for further actions.

The operations included in process 500 are for illustration purposes. Providing content storage management using federated repositories may be implemented by similar processes with fewer or additional steps, as well as in different order of operations using the principles described herein. Specifically, a number of optional operations described in conjunction with FIG. 3 are not listed in the above process. Those and other operations may also be added in any order to process 500.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for managing storage of content using federated repositories, the method comprising:
generating a hierarchical storage system where content and hierarchical structure information is disseminated to subservient nodes from a central hub node in a parent repository of the storage system according to a file plan;
when a change that includes at least one from a set of: a content submission, a modification to the file plan, a policy definition change, and an addition of a new subservient node, is performed at the central hub node, communicating the information associated with the change to a child repository;
if a portion of the communicated information has global effect, communicating the portion of the information to all subservient nodes, wherein each child repository within the storage system includes at least one subservient node.

2. The method of claim 1, further comprising:
when new content submission is received for storage, communicating to a target subservient node information associated with at least one from a set of: a content type, a retention policy, an attribute, a workflow, a user information, a content origin information, and a plurality of query terms associated with the new content.

3. The method of claim 2, wherein at least a portion of the child repositories include a folder structure reporting to the subservient node (“root node”) of each child repository, and wherein the folder structure is updated in response to a modification of the file plan.

4. The method of claim 2, further comprising:
storing related portions of the new content in one of a single child repository and a plurality of child repositories according to the file plan, wherein the new content includes one of: active content, content to be archived, and a combination of active content and content to be archived.

5. The method of claim 2, further comprising:
in response to addition of a new child repository to the storage system, creating a folder structure according to the file plan in the new child repository and communicating the information associated with new content to the new child repository.

6. The method of claim 5, further comprising:
modifying the file plan to route applicable new content to the new child repository.

7. The method of claim 2, further comprising:
in response to a child repository reaching its capacity, retiring the child repository by modifying the content routing within the file plan and designating the retired child repository as archive.

8. The method of claim 1, further comprising:
modifying a retention policy for content stored in at least one child repository in response to one of: an administrator input, an expiration of a predefined period, and a change in hierarchical structure.

9. The method of claim 8, wherein the modification is one of: designating the content to be removed, designating the content to be moved to another location, and designating the content to be retained indefinitely.

10. A system for managing storage of content using federated repositories, the system comprising:
a content management service executed in at least one server associated with a records center, wherein the content management service includes:
a hierarchically structured list of child repositories associated with the records center; and
a file plan module configured to:
maintain content information associated with at least one from a set of: content types, retention policies, attributes, a workflow, user information, and a plurality of query terms associated with content stored in the child repositories;
route new content to applicable child repositories according to a predefined file plan;
update the file plan in response to one of: addition of a new child repository and retiring of a child repository reaching its capacity; and
disseminate folder structure and content information to the child repositories in response to a modification.

11. The system of claim 10, wherein the content management service further includes a query coordinator module for enabling child repositories to query the content management service and receive updated folder structure and content information.

12. The system of claim 10, wherein the content management service further includes a hold requester module for placing selected content in at least one child repository on hold by modifying their retention policy in the file plan.

13. The system of claim 11, wherein each child repository includes at least one from a set of: a physical data store and a virtual data store, and wherein each child repository is managed by one of a content management service server and a local database server.

14. The system of claim 10, wherein a folder structure of each child repository includes a root node associated with the child repository, and wherein an identifier associated with the child repository is maintained as metadata in the root node.

15. The system of claim 14, wherein content management system is configured to maintain at least one of the identifier and a uniform resource locator for each child repository in the hierarchically structured list of child repositories using the metadata.

16. The system of claim 15, wherein the hierarchically structured list of child repositories further includes a designation for each child repository indicating whether the child repository is one of current and archive, the archive designation indicating to the file plan module that no new content is to be routed to the archive designated child repository.

17. A computer-readable storage medium with instructions encoded thereon for managing storage of content using federated repositories, the instructions comprising:
maintaining at a central content management hub content information associated with at least one from a set of: content types, retention policies, attributes, a workflow, user information, content origin information, and a plurality of query terms associated with the content stored in the child repositories;
when new content is received for storage, routing the new content to applicable subservient nodes in the child repositories according to a predefined file plan, wherein related portions of the new content are stored in one of: a single child repository and a plurality of child repositories according to the file plan;
updating the file plan in response to one of: addition of a new child repository and retiring of a child repository reaching its capacity; and
disseminating updated folder structure and content information to the child repositories in response to a modification.

18. The computer-readable storage medium of claim 17, wherein disseminating the updated folder structure and the content information to the child repositories includes:
determining which subservient nodes are affected by the update; and
making the updated folder structure and the content information available to child repositories when they query the central content management hub.

19. The computer-readable storage medium of claim 17, wherein the instructions further comprise:
in response to a hold command from a user, issuing a hold request for selected content to each child repository;
receiving hold reports from child repositories with affected content, wherein the hold reports include a list of stored content in each child repository that has been designated for indefinite retention; and
combining the hold reports into a single system-wide hold report.

20. The computer-readable storage medium of claim 17, wherein the instructions further comprise:
enabling a search to be performed over content stored in all child repositories associated with the central content management hub; and
enabling one of the child repositories to be designated as the central content management hub.
